(19) United States
(12) Patent Application Publication
(10) Pub. No.: US 2009/0128915 A1
(43) Pub. Date: May 21, 2009

(54) Antiglare film and coating composition for making the same

(76) Inventors: Chang-Jian Weng, Chiayi City (TW); Chin-Sung Chen, Taoyuan County (TW); Je-Ting Chiu, Miaoli County (TW)

Correspondence Address: NORTH AMERICA INTELLECTUAL PROPERTY CORPORATION, P.O. BOX 506, MERRIFIELD, VA, 22116, US

(21) Appl. No.: 12/030,880

(22) Filed: Feb. 14, 2008

(30) Foreign Application Priority Data
Nov. 15, 2007 (TW) 096143252

(51) Int. Cl. G02B 27/00

(52) U.S. Cl. 359/601; 428/212

(57) ABSTRACT

The present invention relates to an antiglare film, which comprises a cured transparent resin layer and a type of transparent hollow particles. The hollow particles are distributed in the transparent resin layer and partially exposed therefrom. The ratio of the inner diameter to the outer diameter of the hollow particle is within a range of 0.1 to 0.9, and the ratio of the outer diameter of the hollow particle to the thickness of the transparent resin layer is within a range of 0.1 5 to 1. The hollow particle and the transparent resin layer have different refractive indexes. The hollow particles are partially exposed from the surface of the transparent resin layer, leading the antiglare film to have excellent antiglare properties.

### BACKGROUND OF THE INVENTION

1. Field of the Invention

The present invention relates to an antiglare film and a coating composition for making the antiglare film, which may reduce glare and dazzling caused by light.

2. Description of the Prior Art

Polarizing sheets are often disposed on the outermost surface of display devices. Generally, the polarizing sheets are mainly composed of a polyvinyl alcohol (PVA) film sandwiched between two triacetyl cellulose (TAC) support films. The surface of the TAC films is usually subjected to optical surface treatments, such as, coating a hard coating, or attaching an antiglare film, or an anti-reflecting film, for enhancing physical properties or adding optical functions. The antiglare film is usually made by dispersing some fine particles in a hard coating to achieve an antiglare function, for example, light scattering.

Antiglare films, also referred to as antiglare optical films, conventionally have a structure as shown in FIG. 1. A conventional antiglare film 12 is usually formed through dispersing transparent particles 14 in a transparent resin 16. The transparent resin 16 and the transparent particles 14 having approximate refractive indexes are mixed and then coated on a substrate 10 and cured, to form an optical film 12. Particles in the films are partially exposed from the surface of the film to form a rough surface, causing light 18 to be scattered and refracted on the surface, and thus to achieve antiglare effect. For example, as disclosed in Japan Patent Laid-open Publication No. Hei 6-18706, silica particles are mixed into a resin and then coated on the surface of a transparent substrate to form a layer having concaves and convexes thereon. An antiglare effect is attained when light beams are diffused by the concave and convex surface. However, there is only external light diffusion presented in such method, and the effect from internal light diffusion is not very obvious. Accordingly, an antiglare film having both internal diffusion ability and external diffusion ability is developed by utilizing different amounts of two different types of particles with different sizes and refractive indexes. For example, in U.S. Pat. No. 6,217,176 B1, light-transparent fine particles having two different refractive indexes are mixed in a resin. The difference of refractive index between the two types of light transparent fine particles and the light transparent resin is between 0.03 and 0.2, and the light transparent fine particles have a particle size within a range of about 1 to 5 μm.

Antiglare films can be employed on a surface, such as a surface of a display and the like, when the surface needs to reduce glare and dazzling, and therefore, there is still a need for an antiglare film having a better effect.

### SUMMARY OF THE INVENTION

One objective of the present invention is to provide an antiglare film and a coating composition for making the antiglare film. The light extinction effect and antiglare effect will be enhanced by such antiglare film.

The antiglare film according to the present invention comprises a cured transparent resin layer and a type of transparent hollow particles, wherein, the hollow particles are distributed in the transparent resin layer and partially exposed from the transparent resin layer, the ratio of the inner diameter to the outer diameter of the hollow particles is within a range of 0.1 to 0.9, the ratio of the outer diameter of the hollow particles to the thickness of the transparent resin layer is within a range of 0.15 to 1, and the refractive index of the hollow particles is different from that of the transparent resin layer.

The coating composition for an antiglare film according to the present invention comprises 100 parts by weight of a light curable transparent resin; from 0.3 to 20 parts by weight of transparent hollow particles, wherein the ratio of the inner diameter to the outer diameter of the hollow particles is within a range of 0.1 to 0.9, and the refractive index of the hollow particles is different from that of the light curable transparent resin layer after cured; and a sufficient amount of solvent for the hollow particles to be dispersed in the light curable transparent resin.

In comparison with the conventional techniques, in the present invention, a type of hollow particles are blended or mixed in a transparent resin and partially exposed from the transparent resin. The hollow particle encapsulates air or other gas, or is in vacuum in the hollow portion, such that the hollow portion and the shell body of the hollow particle have different refractive indexes, to cause light beams to be multi-refracted when passing through the hollow particles, improving the light diffusion and the antiglare effect. Accordingly, just a relatively low amount of the hollow particles used in the antiglare film can effectively reduce light glare and dazzling. The antiglare film of the present invention may be used on the surface of various displays of, for example, computers, televisions, or automobile instruments, but not limited thereto.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view of a conventional antiglare film;

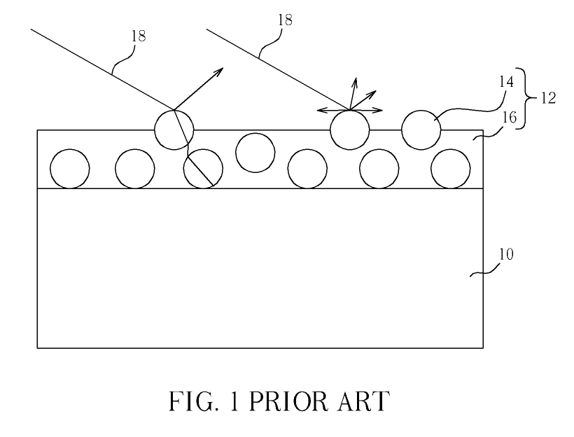

FIG. 2 is a schematic cross-sectional view of an antiglare film according to the present invention;

FIG. 3 is a schematic diagram showing light beam propagation in the antiglare film according to the present invention; and

FIG. 4 shows a data table of test results for the examples according to the present invention and the comparative examples.

### DETAILED DESCRIPTION

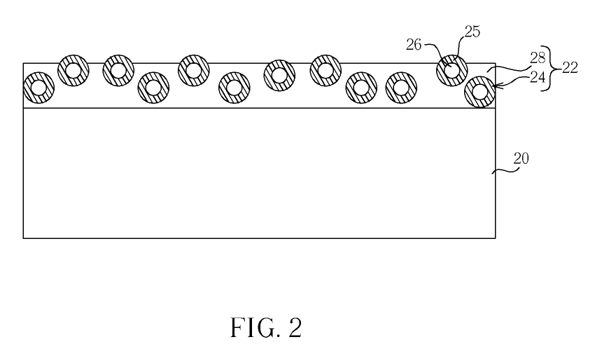

The antiglare film according to the present invention comprises a cured transparent resin layer and a type of transparent hollow particles. FIG. 2 shows an embodiment of the antiglare film according to the present invention. A substrate 20 is covered with an antiglare film 22. The antiglare film 22 comprises a type of hollow particles 24 and a resin layer 28. The hollow particles 24 are particles or particulates sized in micrometers. The hollow particles 24 are preferably uniformly distributed, in the resin layer 28 and partially exposed from the resin layer 28. The hollow particles 24 are light transparent and comprise a shell body 25 and a hollow portion 26. Accordingly, the hollow particles 24 have an inner diameter and an outer diameter. The ratio of the inner diameter to the outer diameter (inner diameter/outer diameter) is within a range of 0.1 to 0.9, and preferably within a range of 0.2 to 0.85. The ratio of the outer diameter of the hollow particles 24 to the thickness of the resin layer 28 is within a range of 0.15 to 1, and preferably within a range of 0.2 to 1. If the shell body is too thin, the shell body tends to be fragile during processing or operation. If the shell body is too thick, the effect of multi-refractions will be insignificant. A proper thickness will render a better refraction result. The resin layer 28 is light transparent. In the present invention, the refractive index of the hollow particles is different from the refractive index of the resin layer. The difference may be for example more than 0.02, and preferably between 0.003 and 0.2, to cause refraction at the interface and facilitate light diffusion.

The hollow particle in the antiglare film according to the present invention may be also referred to as “hollow particulate”. It is spherical with a smooth, rough, or porous surface. When the surface is porous, it is preferred that the hollow particles have a specific surface area of 100 g/m² or more, to favor the dispersion in the transparent resin layer. The outer diameter of the hollow particles may be for example from 1 to 10 μm, and preferably from 1 to 5 μm. The inner diameter of the hollow particles may be for example from 0.1 to 9 μm, and preferably from 0.15 to 4.5 μm. The shell body may comprise a material of organic resin or inorganic oxide, for example, acrylic resins, polystyrenes, acrylic-styrene copolymers, polycarbonates, inorganic silicon oxide compounds, and the like. The hollow portion (or referred to as “the central portion of the hollow particle”) may be air or other gas, or in vacuum, but not particularly limited thereto.

The transparent resin layer in the antiglare film according to the present invention may be an ordinary hard coating, such as, a UV light curable transparent resin layer, which preferably comprises an acrylic functional group. The examples of the resin layer may be preferably polyester resins, polyether resins, acrylic acid resins, epoxy resins, urethane resins, alkyd resins, spiro acetal resins, polythiol-polyene resins, polybutadiene resins, and the like, which has an acrylic functional group and a low molecular weight.

The amount of the cured transparent resin layer or the hollow particles contained in the antiglare film of the present invention is not particularly limited, and it is believed that as long as there are hollow particles dispersed in the cured transparent resin layer, the antiglare effect exhibits. In addition, the amount of the hollow particles to be used may depend on material species, material properties, particle size, inner and outer diameters, and a desired haze value. The haze value probably used for antiglare is usually within a range of about 3 to 90. Therefore, the amount of the hollow particles may depend on the desired haze value. Substantially, the hollow particles may be used in an amount of from 0.3 to 20 parts by weight, more preferably from 0.5 to 15 parts by weight, and most preferably from 1 to 10 parts by weight, based on 100 parts by weight of the cured transparent resin layer, but not limited thereto.

The antiglare film according to the present invention can be applied on many substrates to provide the antiglare function. Particularly, it can be applied to highly transparent organic substrate of, for example, TAC, polyethylene terephthalate (PET), diacetylenecellulose, cellulose acetate butyrate, polyether sulfone, polyacrylic resin, polyurethane resin, polyester, polycarbonate, polysulfone, polyether, polymethyl pentene, polyether ketone, poly(meth)acrylonitrile, or the like. The substrate may be a film having a thickness of for example 25 μm to 300 μm.

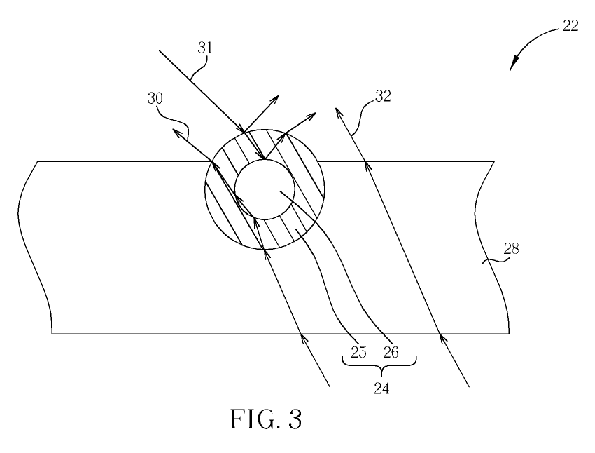

When a light is emitted onto the antiglare film according to the present invention, some hollow particles exposed to the ambient may scatter the light, and this causes an exterior diffusion. Furthermore, the light entering the internal portion of the antiglare film, including the light entering the internal portion of the antiglare film from the ambient or from the substrate, may be multi-refracted when it passes through the hollow particles, and this causes interior light diffusion within the resin layer. For example, FIG. 3 shows light beam propagation in the antiglare film according to the present invention. The light beams 30 and 32 enter the resin layer 28 from the substrate respectively. The light beam 30 encounters the hollow particle 24 and passes the shell body 25, the hollow portion 26, and again the shell body 25 of the hollow particle 24, and thus experiences multi-refractions. Finally, the light beam 30 is scattered at a large scattering angle to diffuse into the ambient environment. The light beam 32 does not encounter the hollow particle 24, but directly passes through the resin layer 28, and then is refracted into the ambient environment. The light beam 31 enters the hollow particle 24 from the ambient environment and is reflected with different reflection angles at the interface between the hollow particle and the ambient environment and at the interface within the hollow particle. Therefore, utilizing the hollow particles in the antiglare film according to the present invention offers the exterior light diffusion effect as well as the interior light diffusion effect. In addition, to achieve a good antiglare effect, only a small amount of the hollow particles is needed.

The antiglare film according to the present invention may be attached to a substrate in a form of a cured film to achieve the antiglare effect, or may be formed on the substrate through coating and curing a pre-made coating liquid on the substrate to achieve the antiglare effect. Such pre-made coating liquid herein is the coating composition for making the antiglare film according to the present invention, which is a mixture and comprises an aforesaid light curable transparent resin, a type of aforesaid transparent hollow particles, and a solvent.

Similar to the description mentioned above, the amounts of the transparent hollow particles and the light curable transparent resin may depend on material species, material properties, particle size, inner and outer diameters, and the desired haze value. Among these, it is preferred that an amount of 0.3 to 20 parts by weight, more preferably 0.5 to 15 parts by weight, and most preferably 1 to 10 parts by weight of transparent hollow particles is used based on 100 parts by weight of the light curable transparent resin. It is preferred that the solvent is used in a sufficient amount to allow the hollow particles to be dispersed in the light curable transparent resin, and preferably allow the whole coating composition to have a viscosity of 5 to 100 CPS, in view of the convenience for coating operation. After the coating composition is coated on the substrate and the transparent resin is cured by irradiation, a cured transparent resin layer as described above is obtained. The solvent is preferably volatile, such that it can be removed through volatilization during the coating and the curing processes. The useful solvent may be, for example, methyl ethyl ketone (MEK), toluene, ethyl acetate, or the like.

Some examples are described hereinafter to detail the fabrication of the antiglare film according to the present invention and compared with comparative examples.

### EXAMPLE

### Example 1

100 parts by weight of UV curable resin was diluted in MEK solvent to form a coating solution with a solid content of about 80%, and 3 parts by weight of silicon dioxide hollow particles with an average particle size of about 3.5 μm was added and stirred to disperse in the UV curable resin, thereby obtaining an antiglare coating solution with a viscosity of 14-18CPS. The coating solution was applied on an 80 μm-thick TAC transparent substrate, and the resultant was placed in an 80° C. air circulating oven to dry for about 1 minute. Thereafter, the resultant was irradiated with a UV light having a dose of 540 mJ/cm², to form an antiglare film of the present invention.

### Example 2

100 parts by weight of UV curable resin was diluted in MEK solvent to form a coating solution with a solid content of about 80%, and 2 parts by weight of acrylic hollow particles with an average particle size of from about 7 to 8 μm was added and stirred to disperse in the UV curable resin, thereby obtaining an antiglare coating solution with a viscosity of 14-18CPS. The coating solution was applied on an 80 μm-thick TAC transparent substrate, and then the resultant is placed in an 80° C. air circulating oven to dry for about 1 minute. Thereafter, the resultant was irradiated with an UV light having a dose of 540 mJ/cm², to form an antiglare film of the present invention.

### Comparative Example 1

100 parts by weight of UV curable resin was diluted in MEK solvent to form a coating solution with a solid content of about 65%, and 3 parts by weight of inorganic silicon oxide particles with an average particle size of about 5 μm and a refractive index of 1.48 was added and stirred to disperse in the UV curable resin. The resultant coating solution was applied on an 80 μm-thick TAC transparent substrate, and then placed in an 80° C. air circulating oven to dry for about 1 minute. Thereafter, the resultant was irradiated with a UV light in a dose of 540 mJ/cm², to form an antiglare film.

### Comparative Example 2

100 parts by weight of UV curable resin was diluted in MEK solvent to form a coating solution with a solid content of about 65%, and 3 parts by weight of organic acrylic particles with an average particle size of about 5 μm and a refractive index of 1.49 was added and stirred to disperse in the above resin. The resultant coating solution was applied on an 80 μm-thick TAC transparent substrate, and then placed in an 80° C. air circulating oven to dry for about 1 minute. Thereafter, the resultant was irradiated with a UV light in a dose of 540 mJ/cm², to form an antiglare film.

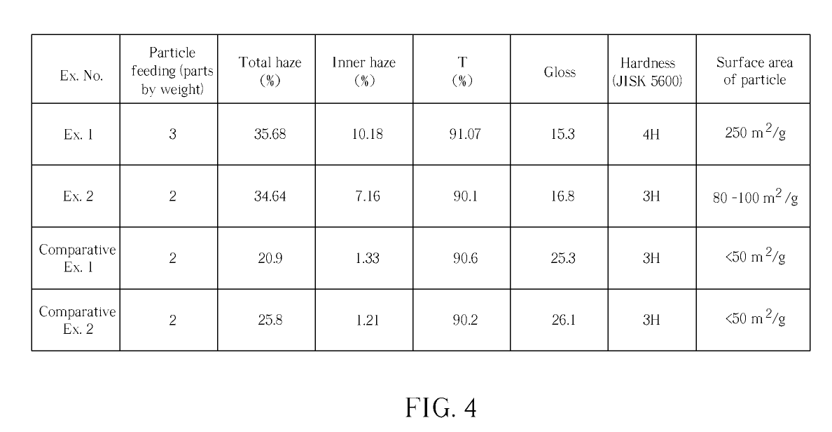

The test results of the antiglare films made from Examples 1 and 2 and Comparative Examples 1 and 2 are listed in the data table shown in FIG. 4. The haze value was tested in accordance with the method specified in JIS K 7105, the gloss was tested in accordance with the method specified in JIS Z 8741, and the hardness was tested in accordance with the method specified in JIS K 5600. It is known from the results shown in the data table that the haze value of the antiglare film using hollow particles is superior to the haze value of the antiglare film using solid particles as antiglare particulates. As shown by Examples 1 and 2, either the silicon dioxide hollow particles or the acrylic hollow particles are used as antiglare particulates, the optical performance of the resultant films is superior to those using the solid particles as antiglare particulates in Comparative Examples 1 and 2. In a condition that the different particles are used in a same amount, the antiglare film of the present invention not only has an increased haze value, but also has an increased internal haze value due to interior multi-refraction and diffusion. Furthermore, the gloss is reduced due to the reduction of the surface reflection caused by partially exposed particles. Accordingly, the antiglare effect of the transparent material is truly enhanced by adding the hollow particles. In addition, with respect to the porous hollow particles, the greater surface area, the better dispersion thereof in the resin.

Those skilled in the art will readily observe that numerous modifications and alterations of the device and method may be made while retaining the teachings of the invention.

What is claimed is:

1. An antiglare film, comprising:
a cured transparent resin layer; and
a type of transparent hollow particles, wherein,
the hollow particles are distributed in the transparent resin layer and partially exposed from the transparent resin layer,
the ratio of the inner diameter to the outer diameter of the hollow particles is within a range of 0.1 to 0.9,
the ratio of the outer diameter of the hollow particles to the thickness of the transparent resin layer is within a range of 0.15 to 1, and
the refractive index of the hollow particles is different from that of the transparent resin layer.

2. The antiglare film of claim 1, wherein the hollow particles comprise an organic resin or an inorganic oxide.

3. The antiglare film of claim 2, wherein the hollow particles comprise one selected from the group consisting of acrylic resins, polystyrenes, acrylic-styrene copolymers, polycarbonates, and inorganic silicon oxide compounds.

4. The antiglare film of claim 1, wherein the diameter of the hollow particles is within a range of 1 to 10 micrometers.

5. The antiglare film of claim 1, wherein the hollow particles are in a spherical shape.

6. The antiglare film of claim 1, wherein the hollow particles have a smooth surface.

7. The antiglare film of claim 1, wherein the hollow particles have a rough surface.

8. The antiglare film of claim 1, wherein the hollow particles have a porous surface.

9. The antiglare film of claim 1, wherein the hollow portion of the hollow particles comprises a gas or air or is in a vacuum.

10. The antiglare film of claim 1, wherein the cured transparent resin layer is presented in an amount of 100 parts by weight, and the hollow particles are presented in an amount of 0.3 to 20 parts by weight.

11. The antiglare film of claim 1, wherein the cured transparent resin layer comprises a UV-cured transparent resin layer.

12. The antiglare film of claim 1, wherein the cured transparent resin layer comprises one selected from the group consisting of polyester resins, polyether resins, acrylic acid resins, epoxy resins, urethane resins, alkyd resins, spiro acetal resins, polythiol-polyene resins, and polybutadiene resins, each having an acrylic functional group.

13. A coating composition for an antiglare film, comprising:
100 parts by weight of a light curable transparent resin;
0.3 to 20 parts by weight of transparent hollow particles, wherein the ratio of the inner diameter to the outer diameter of the hollow particles is within a range of 0.1 to 0.9, and the refractive index of the hollow particles is different from that of the light curable transparent resin layer after cured; and
a sufficient amount of solvent for the hollow particles to be dispersed in the light curable transparent resin.

14. The coating composition of claim 13, wherein the hollow particles comprise an organic resin or an inorganic oxide.

15. The coating composition of claim 14, wherein the hollow particles comprise one selected from the group consisting of acrylic resins, polystyrenes, acrylic-styrene copolymers, polycarbonates, and inorganic silicon oxide compounds.

16. The coating composition of claim 13, wherein the hollow particles have a particle size within a range of 1 to 10 micrometers.

17. The coating composition of claim 13, wherein the hollow particles are in a spherical shape.

18. The coating composition of claim 13, wherein the hollow particles have a smooth surface.

19. The coating composition of claim 13, wherein the hollow particles have a rough surface.

20. The coating composition of claim 13, wherein the hollow particles have a porous surface.

21. The coating composition of claim 13, wherein the hollow portion of the hollow particles comprises a gas or air or is in a vacuum.

22. The coating composition of claim 13, wherein the light curable transparent resin comprises a UV curable transparent resin.

23. The coating composition of claim 13, wherein the light curable transparent resin comprises one selected from the group consisting of polyester resins, polyether resins, acrylic acid resins, epoxy resins, urethane resins, alkyd resins, spiro acetal resins, polythiol-polyene resins, and polybutadiene resins, each having an acrylic functional group.
